(19) United States
(12) Patent Application Publication
(10) Pub. No.: US 2020/0379732 A1
(43) Pub. Date: Dec. 3, 2020

(54) A SYSTEM AND METHOD FOR SORTING DIGITAL IMAGES

(71) Applicant: ARTlife Solutions Pty Ltd, Wynnum (AU)

(72) Inventors: Sarah Smith, Kelvin Grove (AU); Majella Edwards, Wynnum (AU)

(21) Appl. No.: 16/971,002

(22) PCT Filed: Feb. 19, 2019
(86) PCT No.: PCT/AU2019/000019

§ 371 Date: Aug. 19, 2020

(30) Foreign Application Priority Data
Feb. 22, 2018 (AU) 2018201311

(51) Int. Cl. G06F 7/22; G06F 16/51; G06F 16/54; G06T 7/00; G06N 7/02; H04L 29/08; H04L 29/06

(52) U.S. Cl. CPC G06F 7/22; G06F 16/51; G06F 16/54; H04L 65/60; G06N 7/02; H04L 67/06; G06T 7/0002

(57) ABSTRACT

A method for sorting digital images, the method comprising the steps of:
a) Receiving a digital image acquired with an electronic device associated with a user, the digital image being sent using the electronic device to an electronic image sorting system;
b) Generating, using an image analysis portion of the electronic image sorting system, one or more initial identifiers based on the contents of the digital image;
c) Sending the one or more initial identifiers to an identifier analysis portion of the electronic image sorting system, wherein the identifier analysis portion includes an electronic database of one or more rules adapted to generate one or more additional identifiers based on the one or more initial identifiers;
d) Sending, using the electronic image sorting system, the one or more initial identifiers and/or the one or more additional identifiers, to the electronic device to allow the user to generate one or more selected identifiers from the one or more initial identifiers and/or the one or more additional identifiers; and
e) Modifying the one or more rules based on the one or more selected identifiers.

### TECHNICAL FIELD

The present invention relates to a system and method for sorting digital images. In particular, the present invention relates to a system and method for sorting and retrieving digital images according to their human meaning.

### BACKGROUND ART

The advent of digital cameras and smartphones has provided the average person with the ability to create vast numbers of digital images. Typically, the creation and storage of these digital images is free, meaning that there are few, if any, limits on the number of digital images that a single person can produce and store.

However, the creation of large numbers of images can make it difficult for a user to search and find images among their collection, particularly when images are stored across multiple electronic devices. In this situation, photos can be ‘lost’, forgotten or stored in a range of locations with no automated and/or simple way to retrieve them again in a matter of seconds.

Some attempts have been made to overcome this problem. For instance, computer vision technology may analyse an image and identify certain physical objects that appear in the image. Identifiers (“tags”) related to these physical objects may be associated with the image, allowing the image to be retrieved by searching for particular tags.

However, what this technology cannot do is identify “human meaning”, (such as the emotions felt by a person when viewing a particular image (as opposed to the emotions of any people in the image to an image), the context behind an image, the intent or purpose of the image and so on), in an image and tag the image appropriately. As a result, a user's ability to retrieve images is limited to remembering what physical objects are present in a particular image. In many cases, the emotions felt when looking at an image may be stronger (and therefore, easier for a user to recall) than the physical objects contained in an image.

Thus, there would be an advantage if it were possible to provide a system that allowed a user to search and retrieve digital images based on the “human meaning” of an image. The concept of “human meaning” in relation to this invention can be defined by the following attributes:
the relationship between objects, behaviours, people, time, emotions and activities and by how a user relates to those items individually and collectively.
thoughts and emotions felt by the user who is viewing an image.
the thoughts, emotions and sensations experienced by the user when an image is created or acquired.
the user's judgements, opinions, reactions and actions to the content of the image.
the interpreted context and intent of the photo which aligns or misaligns with a user's mindset, belief system, humour and/or values.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a system and method for sorting digital images which may at least partially overcome at least one of the abovementioned disadvantages or provide the consumer with a useful or commercial choice.

With the foregoing in view, the present invention in one form, resides broadly in method for sorting digital images, the method comprising the steps of:
a) Receiving a digital image acquired with an electronic device associated with a user, the digital image being sent using the electronic device to an electronic image sorting system;
b) Generating, using an image analysis portion of the electronic image sorting system, one or more initial identifiers based on the contents of the digital image;
c) Sending the one or more initial identifiers to an identifier analysis portion of the electronic image sorting system, wherein the identifier analysis portion includes an electronic database of one or more rules adapted to generate one or more additional identifiers based on the one or more initial identifiers;
d) Sending, using the electronic image sorting system, the one or more initial identifiers and/or the one or more additional identifiers, to the electronic device to allow the user to generate one or more selected identifiers from the one or more initial identifiers and/or the one or more additional identifiers; and
e) Modifying the one or more rules based on the one or more selected identifiers.

It will be understood that the term “acquiring” a digital image may include any suitable method of creating a digital image. For instance, a digital image may be generated through taking a photo or video etc. using a digital camera. Alternatively, the digital image may be acquired by generating a digital image using a drawing, drafting or video editing software program. Still further, a digital image may be acquired by the electronic device by downloading a digital image (whether a photograph or video) from an electronic message (text message, email message or the like) or from a source of digital images, such as an electronic image database or the Internet. In other embodiments of the invention, a digital image may be acquired by converting an analog image (such as a photograph taken using analog photography, or an analog video) into a digital image (for instance, by scanning the analog image, or some other suitable technique). A digital image may also be acquired through the use of ‘photographing’ a device screen display, otherwise known as a “Screen Capture” or “Screen Shot”.

The electronic device may be of any suitable form. For instance, the electronic device may comprise an electronic device capable of taking digital photos (i.e. an electronic device equipped with a camera, such as a mobile telephone, computing tablet, digital camera or the like). Alternatively, the electronic device may comprise an electronic device not capable of taking photos, but capable of acquiring digital images by scanning, downloading, from electronic storage or the like (such as a desktop computer or a laptop computer).

The digital image may be sent from the electronic device to the electronic image sorting system using any suitable technique. For instance, the digital image may be sent as a text message, email, video message or the like, or any suitable combination thereof. Alternatively, the digital image may be sent to the electronic image sorting system via the Internet, for instance using Wi-Fi. Alternatively, the digital image may be sent to the electronic image sorting system using other techniques, such as Bluetooth, Cloud computing or the like. In these embodiments of the invention, it is envisaged that the electronic image sorting system may be housed on an electronic device (such as a server) remotely to the user.

In other embodiments of the invention, the user may be required to access an electronic application downloaded to the electronic device, or a website, in order to send the digital image to the electronic image sorting system. In this embodiment, it is envisaged that the electronic application and the website may be hosted on an electronic device, such as a server.

The electronic image sorting system preferably includes one or more user interfaces which with a user can interact. The electronic image sorting system may require a user to open an account with the electronic image sorting system before being able to access the electronic image sorting system. Alternatively, the electronic image sorting system may be open to any user to access without requiring an account.

As previously mentioned, it is envisaged that the electronic image sorting system may comprise one or more user interfaces. In a preferred embodiment of the invention, at least one of the one or more user interfaces may comprise a user interface in which a user may upload a digital image to the electronic image sorting system. The digital image may be uploaded to the electronic image sorting system from electronic storage on the electronic device, may be uploaded directly from the camera of the electronic device, or may be uploaded from an Internet address specified by the user (for instance, a social media platform, photo sharing service or the like).

In some embodiments of the invention, digital images uploaded to the electronic image sorting system may be stored in electronic storage associated with the electronic image sorting system. In some embodiments of the invention, all digital images uploaded to the electronic image sorting system may be stored communally in the electronic storage. Alternatively, digital images may be associated with the user that uploaded the digital images to the electronic image sorting system, such that only that user may access the digital images he or she uploaded.

Alternatively, the digital image itself may not be stored in electronic storage associated with the electronic image sorting system. Instead, certain data (e.g. metadata) associated with the digital image may be stored in electronic storage associated with the electronic image sorting system. A user may use the electronic image sorting system to retrieve a digital image stored on the electronic device (or an alternative electronic device associated with the user) using the data associated with the digital image and stored in the electronic storage of the electronic image sorting system. In other embodiments of the invention, a relatively low-resolution version of the digital image (such as a thumbnail image) may be stored in electronic storage associated with the electronic image sorting system, along with any relevant data (e.g. metadata).

In some embodiments, a user may have the ability to associate digital images with other users of the electronic image sorting system. For instance, if a user wishes to share certain digital images with other users (such as family or friends) the user may elect to associate a particular image with one or more other users. In this embodiment of the invention, it is envisaged that all users with which a particular digital image is associated may be able to access that image.

As stated previously, the electronic image sorting system includes an image analysis portion that generates one or more initial identifiers based on the contents of the digital image. The image analysis portion may be of any suitable form, although in some embodiments of the invention, the image analysis portion may include one or more computing units capable of generating the one or more initial identifiers. In a particular embodiment, the image analysis portion may include one or more computer vision units.

As mentioned above, the one or more initial identifiers may be generated based on the contents of the digital image. Any suitable contents of the digital image may be relied upon to generate the one or more initial identifiers. For instance, the one or more initial identifiers (commonly referred to as “tags”) may be generated based on physical objects present in the digital image (such as people and/or animals, buildings and other structures, vehicles, natural objects such as trees, plants and flowers, clouds, rivers, beaches and so on). Further, the one or more initial identifiers may be generated based on machine- or human-readable information present in the digital image. Any suitable information may be used to generate the one or more initial identifiers, although in some embodiments of the invention, the information may include written text, diagrams or plans, classification codes (such as hazardous material codes or the like), street signs, electronically readable codes (such a barcodes, QR codes or the like) or any suitable combination thereof.

In some embodiments, colours present in the digital image, particularly dominant or noticeable colours, may be used as initial identifiers. The initial identifiers based on colours may be sent to the identifier analysis portion in any suitable form. For instance, the initial identifiers based on colours may simply be the names of the colour (e.g. “red”, “blue” etc.), or may be in the form of standardised colours (e.g. based on the Pantone colour scheme). Alternatively, the initial identifiers based on colour may be provided to the identifier analysis portion in machine readable format, such as, but not limited to, one or more RGB tuples.

Initial identifiers may also be generated based on scene recognition. For instance, the image analysis portion may generate initial identifiers based on generic locations (e.g. “store”, “park”, “house” etc.) or may generate initial identifiers based on specific locations (e.g. “Eiffel Tower”, “New York”, “Australia” etc.).

In some embodiments, an initial identifier may include GPS co-ordinates of the location at which the digital image was taken, the time and/or date at which the digital image was taken and so on. This initial identifier may be generated based on metadata associated with the digital image, or may be determined by interrogating one or more external electronic databases, websites, electronic applications or the like, or a combination thereof. The initial identifiers may also include identifiers extracted from text portions of a user's calendar and social media systems and from other metadata found within the embedded information of an image such as camera type and lens.

For instance, if a user uploads an image from a social network platform (such as Facebook, Instagram or the like), the image analysis portion may access details of the digital image available on the social network platform (such as the date and time the image was generated/uploaded, any location tags associated with the image, any people tagged in the image and so on). One or more initial identifiers may be generated base on the information accessed from the social network platform.

In some embodiments of the invention, initial identifiers based on locations may be used to generate a map of an area or region. For instance, if a digital image includes points of interest (e.g. streets, buildings, stores, fences, walls, parks, swimming pools, banks, rivers, bridges, beaches etc.) these points of interest may be added to a map. This is particularly the case if GPS co-ordinates may also be associated with the point of interest. Over time, a map may be developed that a user may be able to access using the digital image sorting system to find or navigate to a particular location.

In this embodiment of the invention, it is envisaged that, as locations change (for instance, as new buildings are built, or business close and are replaced by new businesses) subsequent initial identifiers may be used to overwrite out of date or obsolete information regarding a particular location.

In embodiments of the invention in which people are present in the digital image, the initial identifiers may include the names of one or more of the people in the digital image. The names of the people may be generated using facial recognition technology. In addition, the initial identifiers may include one or more emotions. It is envisaged that the one or more emotions may be determined based on the expressions of the people in the digital image. For instance, if the people in the digital image are smiling, the image analysis portion may generate an initial identifier of “happy”. Similarly, if the people in the digital image are crying, the image analysis portion may generate an initial identifier of “sad”.

Other computer vision units may include plant recognition computer visions units, animal/pet recognition computer vision units, food recognition computer vision units, age recognition computer vision units and the like.

In some embodiments of the invention, all of the computer vision units may be in use at all times for all users of the electronic image sorting system. Alternatively, only one or more of the computer vision units may be in use. Which of the computer vision units are in use may depend on a number of factors. For instance, only certain computer vision units may be in use for certain users based on one or more factors (such as age, gender, geographical location, interests and the like). Alternatively, a user may select which of the computer vision units it wishes to enable for use with his or her digital images. For instance, if a particular user does not have a pet, the user may elect not to make use of the animal/pet recognition computer vision unit. In other embodiments of the invention, the electronic image sorting system may determine which computer vision units best match the contents of a user's digital images and may only enable one or more computer vision units that best match the contents of the digital images. This may be done on a user-by-user basis, or may be continually or periodically adjusted as a user's digital image library grows in size.

Thus, the image analysis portion may generate the one or more initial identifiers based on one or more visual cues present in the digital image and/or one or more pieces of information retrieved from one or more information sources external to the electronic image sorting system and/or one or more pieces of information retrieved from metadata associated with the digital image.

The one or more visual cues present in the digital image may include physical objects, machine- or human-readable information, colours, scene or location recognition, emotion recognition, facial recognition, age recognition, plant recognition, animal/pet recognition, food recognition and so on. The one or more pieces of information retrieved from one or more information sources external to the electronic image sorting system may include location, GPS co-ordinates, calendar entries, time and so on. Thus, the one or more information sources may include social media platforms, websites, electronic calendars, electronic location services and the like. The one or more pieces of information retrieved from metadata associated with the digital image may include GPS co-ordinates, time, date, camera type, lens type and so on.

Once the image analysis portion has generated the one or more initial identifiers, the one or more initial identifiers are sent (preferably electronically) to the identifier analysis portion of the electronic image sorting system. As previously stated, the identifier analysis portion includes an electronic database of one or more rules adapted to generate one or more additional identifiers based on the one or more initial identifiers. It is envisaged that, in a preferred embodiment of the invention, transmitting identifiers and rules to and from the identifier analysis portion and database substantially removes the need to transmit large digital images themselves. In this manner, costs for the storage of large electronic files may be reduced, while also maintaining users' privacy, reducing the load on electronic transmission systems (e.g. internet costs) and improving speed. Thus, a user's images preferably remain in their device. In a preferred embodiment of the invention, a relatively small, low resolution image of the digital image (e.g. a thumbnail image) may be stored in the electronic image sorting system (i.e. for display on an electronic interface).

It is envisaged that the one or more rules may be stored in an electronic rules database. Preferably, the electronic rules database may be associated with a rules engine.

The one or more additional identifiers may be generated by the identifier analysis portion using any suitable technique. Preferably, however, when an initial identifier is received by the identifier analysis portion, the identifier analysis portion may consult and/or enact one or more of the rules that exactly and/or closely match the initial identifiers. Additional identifiers may then be generated based on the additional identifiers associated with the enacted rules. Additional identifiers may be generated using any suitable technique. Preferably, however, the additional generators may be generated using fuzzy logic and/or one or more weightings (discussed later).

For instance, if an initial identifier includes the word “boat”, the identifier analysis portion may enact and/or consult any rules that exactly match the word “boat” and/or any rules that closely match the word “boat” (such as “boats”, “ship”, “yacht” or associated identifiers such as “marina”, “harbour”, “sail” or the like).

Similarly, if an initial identifier is a colour in the form of an RGB tuple, rules using colours that are close in RGB space may be used as close matches. Further, rules using GPS co-ordinates that are close in distance to the GPS co-ordinates of the initial identifier may be used as additional identifiers.

In some embodiments of the invention, additional identifiers that exactly match the initial identifier may be given the same weight as additional identifiers that are close matches to the initial identifier. Thus, all identifiers generated by the identifier analysis portion may be additional identifiers.

In an alternative embodiment of the invention, however, not all identifiers generated by the identifier analysis portion may be additional identifiers. In this embodiment of the invention, the identifier analysis portion may generate one or more intermediate identifiers based on the initial identifiers. However, the one or more intermediate identifiers may be weighted based on the degree of matching to the initial identifier. For example, intermediate identifiers generated from rules that are exact matches in words, colours and GPS co-ordinates to the initial identifiers may be weighted more heavily than intermediate identifiers generated from rules that are only close matches to the initial identifiers. Similarly, when at least a significant portion of the intermediate identifiers are generated from rules that are only close matches to the initial identifiers, the intermediate identifiers that most closely match the initial identifiers may be weighted more heavily than intermediate identifiers that less heavily match the initial identifiers. Thus, the one or more weightings include a higher weighting for intermediate identifiers that more closely match the initial identifiers and lower weightings for intermediate identifiers that less closely match the initial identifiers

In this embodiment of the invention, the additional identifiers may be selected from the intermediate identifiers using any suitable technique. For instance, in situations in which a relatively small number of intermediate identifiers are generated, all of the intermediate identifiers may be selected as additional identifiers. Alternatively, where relatively large numbers of intermediate identifiers are generated, only the most relevant portion (i.e. the most heavily weighted intermediate identifiers) may be selected as additional identifiers. The additional identifiers may be selected based on any suitable criteria. For instance, the additional identifiers may be selected based on an optimum number of additional identifiers, or on a percentage or proportion of intermediate identifiers. Alternatively, an intermediate identifier assigned a weighting above a predetermined relevance value may be selected as an additional identifier.

Preferably, once the additional identifiers have been generated, the additional identifiers and/or the initial identifiers may be sent to the electronic device of the user (or, in some embodiments, a user interface provided on the display of the electronic device of the user). The user may then select one or more of the additional identifiers and/or the initial identifiers to create one or more selected identifiers associated with the image. In some embodiments, a user may manually enter their own additional identifiers which feed into the overall set of additional identifiers available.

Alternatively, once the additional identifiers have been generated, the one or more additional identifiers and/or the one or more initial identifiers may be compared against a database of images. Any suitable database of images may be used. For instance, the database of images may be a database of images associated with the user (e.g. stored on one or more electronic devices of the user and/or in the user's Cloud storage and/or in a user's social media accounts). Alternatively, the database of images may be associated with multiple users of the electronic image sorting system. In some embodiments of the invention, the images against which the additional identifiers and/or the initial identifiers may be compared may be a database of all images of all users of the electronic image sorting system. Alternatively, the database of images against which the additional identifiers and/or the initial identifiers may be compared may be a subset of the database of all images of all users of the electronic image sorting system. The subset may be determined based on any suitable criteria, including, but not limited to, the age of the user, the gender of the user, the geographical location of the user, the interests of the user and the like, or any suitable combination thereof. Thus, in this way, the accuracy or relevance of the additional identifiers and/or the initial identifiers may be improved or enhanced by comparing the digital image against digital images of other users of similar age, gender, location, interests or the like. While it is envisaged that the database of images may include actual images, it is also envisaged that the database of images may not include actual images, but may instead comprise metadata (including selected identifiers) associated with particular images. In a further embodiment of the invention, the database may comprise a database of relatively small, low-resolution images (e.g. thumbnail images) of the original digital images.

In an alternative embodiment of the invention, once additional identifiers have been generated and/or selected by a user, that interaction is used to strengthen the weighting of the rule that produced the additional identifier. Rules are thus adjusted for accuracy and relevance and shared across the users of the electronic image sorting system the most up-to-date version of the rule is made available to other users of the system. Preferably, the rules are accessed by other users by searching a database keyed on the initial identifiers which are required for the rule. In addition to retrieving rules from the database based on initial identifiers, a subset of rules and their concomitant additional identifiers may be produced with higher weightings and made available to the electronic device.

Preferably, each of the images in the database has one or more selected identifiers associated therewith. By comparing the one or more additional identifiers and/or the one or more initial identifiers against a database of images, one or more further additional identifiers may be generated based on similar images of the user and/or another user of the electronic image sorting system. In a particular embodiment, the one or more further additional identifiers may preferably be associated with the human meaning of the image. It will be understood that the term “human meaning” refers to the emotions felt by a person when viewing a particular image (as opposed to the emotions of any people in the image to an image), the context behind an image (i.e. a birthday party, graduation, holiday, an image of an absent or deceased person etc.), the intent or purpose of the image (to celebrate a particular event, to reminisce about a person or event etc.) and so on

It will be understood that the human meaning of an image may be very different to what is displayed in the image itself. For instance, a person may react with sadness to an image of a deceased friend or loved one, even if the image itself shows the deceased person to be smiling. Similarly, a person may react with happiness or joy to an image of an animal (such as a pet). However, in this example, there would be nothing in the image of the animal itself that would indicate or predict such a reaction.

In other examples, while facial recognition techniques may identify individual people within an image, the human meaning may be different. For instance, the human meaning of a group of people in an image may be “school reunion”, “girls' night out”, “best friends”, “happy” or the like, or any suitable combination thereof.

It is envisaged that, to generate the one or more further additional identifiers, the additional identifiers and/or the initial identifiers may be compared against the images in the database of images to locate images with similar additional identifiers and/or the initial identifiers. One or more of the selected identifiers associated with those images may then be used as the further additional identifiers.

For instance, if the additional identifiers and/or the initial identifiers include the names of people in the image (identified using facial recognition technology), and the electronic image sorting system identifies the same group of people in one or more images in the database of images, one or more of the selected identifiers associated with those images may be used as the further additional identifiers. Similarly, if the electronic image sorting system identifies in the image the same location, activity, object(s), colour(s), information etc. as one or more other images in the database of images, the electronic image sorting system may generate one or more further additional identifiers based on the selected identifiers associated with those images.

It is envisaged that, upon generation of the further additional identifiers, the further additional identifiers and the additional identifiers (referred to collectively for simplicity as “additional identifiers”) and/or the initial identifiers may be sent to the electronic device of the user. The additional identifiers may be of any suitable form.

For instance, the additional identifiers may be in the form of words, names, pictures, drawings, emojis, symbols, numbers, animations (e.g. gifs), videos, music or the like, or any suitable combination thereof.

As previously stated, the additional identifiers and/or the initial identifiers may be sent to the electronic device of the user (or, in some embodiments, a user interface provided on the display of the electronic device of the user). The user may then select one or more of the additional identifiers and/or the initial identifiers to create one or more selected identifiers associated with the image. In some embodiments of the invention, the user may generate one or more of selected identifiers of their own choosing to be associated with the image.

Once the selected identifiers have been associated with the image by the user, metadata relating to the image (including the selected identifiers) may be stored in the database of images. In addition, in some embodiments of the invention, the image may be stored in the database of images.

As mentioned previously, the one or more rules are modified based on the one or more selected identifiers. It is envisaged that, once selected identifiers are generated, the electronic image sorting system may modify the rules by generating one or more new rules based on the selected identifiers. Alternatively, the electronic image sorting system may update existing rules by associating the digital image with a rule based on a selected identifier. In embodiments in which two or more selected identifiers are associated with a digital image, the electronic image sorting system may link or associate rules for at least two of the selected identifiers with one another. In further embodiments of the invention, the electronic image sorting system may adjust the weightings given to one or more of the additional identifiers and/or the initial identifiers based on the selected identifiers. Thus, rules may be modified based on the one or more selected identifiers by generating new rules, updating rules with new selected identifiers, modifying the weighting of rules and/or linking or associating two or more rules.

In another embodiment of the invention, the electronic image sorting system may further comprise an image retrieval portion. In this embodiment of the invention, it is envisaged that a user may access the image retrieval portion using the electronic device (for instance, through an electronic interface of the electronic image sorting system provided on the display of the electronic device).

Preferably, the electronic image sorting system may adapted to retrieve digital images from one or more electronic devices based on one or more selected identifiers. Any suitable images may be retrieved. For instance, the user may be able to retrieve any image sent to the electronic image sorting system by any user. More preferably, the user may be able to retrieve any image to the electronic image sorting system by any user that has provided the user with permission to retrieve their images. Alternatively, the user may only be able to retrieve images that he or she has sent to the electronic image sorting system.

It is envisaged that the user may retrieve images by entering one or more selected identifiers into the image retrieval portion (for instance, via an electronic interface provided on the display of the user's electronic device). Preferably, once the selected identifiers have been identified, the image retrieval portion may retrieve all images in the database of images that have selected identifiers matching those entered by the user. The retrieved images may then be made available to the user for viewing on the electronic device or for download.

The image retrieval portion may retrieve images from any suitable location. In a preferred embodiment of the invention, however, the image retrieval portion may retrieve images stored on one or more electronic devices of the user and/or in the user's Cloud storage and/or in a user's social media accounts.

In some embodiments of the invention, once an image has been retrieved, a user may be able to add, remove or change selected identifiers associated with the image. This may be desirable if a user's emotions towards the subject of an image have changed over time. For instance, when a romantic relationship has ended, a user may wish to retrieve images of their former romantic partner and delete selected identifiers such as “love” and/or replace these with alternative selected identifiers such as “sad” or even “hate”. Similarly, a user may wish to add new selected identifiers to images of a recently deceased friend or family member.

When user-initiated changes to selected identifiers associated with particular images are made, it is envisaged that the electronic image sorting system may make modifications to the rules in the same manner discussed previously.

In another aspect, the invention resides broadly in a system for sorting digital images, the system comprising: at least one processor, at least one non-transitory computer readable storage medium storing instructions thereon, that, when executed by the at least one processor, cause the system to:
a. Receive, from an electronic device associated with a user, a digital image sent using the electronic device to an electronic image sorting system;
b. Generate, using an image analysis portion of an electronic image sorting system, one or more initial identifiers based on the contents of a digital image;
c. Send, using the electronic image sorting system, the one or more initial identifiers to an identifier analysis portion of the electronic image sorting system, wherein the identifier analysis portion includes an electronic database of one or more rules adapted to generate one or more additional identifiers based on the one or more initial identifiers;
d. Send, using the electronic image sorting system, the one or more initial identifiers and/or the one or more additional identifiers, to the electronic device to allow the user to generate one or more selected identifiers from the one or more initial identifiers and/or the one or more additional identifiers; and
e. Modify, using the electronic image sorting system, the one or more rules based on the one or more selected identifiers

The present invention provides numerous advantages over the prior art. For instance, the ability to associate human meaning with an image means that a user can more accurately tag their images. This makes the retrieval of the images easier (for instance, by retrieving images that make the user happy) rather than having to remember the exact contents of an image (such as the colour of the dress a family member was wearing in a particular image, where or when an image was taken, other objects in the image and so on), particularly if the user has images stored across a number of electronic devices, in Cloud storage or the like.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a schematic diagram of a method and system for sorting digital images according to an embodiment of the present invention.

FIG. 2 illustrates a schematic diagram of a method and system for sorting digital images according to an embodiment of the present invention.

### DESCRIPTION OF EMBODIMENTS

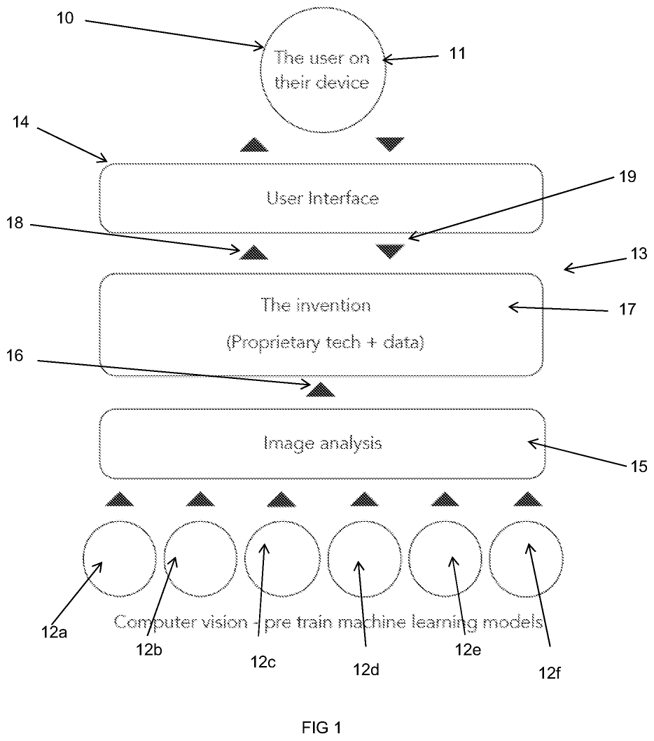

In FIG. 1 there is illustrated a schematic diagram of a system and method for sorting digital images. In this Figure, a user 10 acquires a digital image using an electronic device. In the embodiment of the invention shown in FIG. 1, the electronic device comprises a mobile telephone 11. While it is envisaged that the mobile telephone 11 may include a camera capable of acquiring digital images by taking them using the camera, it will be understood that digital images may be acquired by the mobile telephone 11 in a number of ways, including being downloaded from the Internet, or from within a text message, email message, instant messaging system message and so on.

Digital images are sent by the user 10 to the electronic image sorting system 13 using the mobile telephone 11. In the embodiment of the invention shown in FIG. 1, the user 10 accesses the electronic image sorting system 13 through an electronic interface 14 provided on the display of the mobile telephone 11. In this embodiment of the invention, it is envisaged that the electronic interface 14 may be provided in the form of an electronic application (i.e. an “app”) downloaded to the mobile telephone 11. However, it is also envisaged that the user 10 may access the electronic image sorting system 13 through a website or the like.

In FIG. 1, the user 10 upload a digital image to the electronic image sorting system 13 through the user interface 14. The digital image is received by an image analysis portion 15 of the electronic image sorting system 13, whereupon the image analysis portion 15 (including one or more computer vision units) generates one or more initial identifiers 16 based on the contents of the digital image. The computer vision units in the embodiment of the invention shown in FIG. 1 are a facial recognition/emotion recognition computer vision unit 12a, a colour detection computer vision unit 12b, an age detection computer vision unit 12c, a GPS co-ordinate and location detection computer vision unit 12d, a calendar and date/time detection computer vision unit 12e and an object detection computer vision unit 12f.

Initial identifiers 16 generated for input to the image analysis portion 17 may include outputs from different categories of computer vision units 12a-12f, metadata associated with the digital image or other sources (such as social media platforms, websites, electronic calendars, electronic location services and the like). For example, the object recognition computer vision unit 12f may output initial identifiers 16 such as “chair” and “table” to be input to the image analysis portion 17, while the emotion recognition computer vision unit 12c may output an initial identifier 16 such as “smile”. Similarly, the colour detection computer vision unit 12b may output an initial identifier 16 such as “red”.

Initial identifiers 16 are sent to an identifier analysis portion 17 of the electronic image sorting system 13. The identifier analysis portion 17 compares the initial identifiers against a database of rules in order to generate one or more additional identifiers 18. At least one of the one or more additional identifiers 18 includes an identifier based on the human meaning of the digital image 24.

In the embodiment of the invention shown in FIG. 1, only the additional identifiers 18 are sent to the user 10 through the electronic interface 14, although it will be understood that, in other embodiments, one or more initial identifiers 16 may also be sent to the user 10. The specific details of the generation of the additional identifiers will be described in more detail later.

Upon receipt of the additional identifiers 18, the user 10 selects one or more of the additional identifiers 18 that he or she believes best describe the digital image 24. The additional identifiers 17 chosen by the user 10 become the selected identifiers 19. The selected identifiers 19 are associated with the digital image 24 such that a user 10 can retrieve a particular image by searching the electronic image sorting system 13 for selected identifiers 19.

Once the selected identifiers 19 are entered into the electronic image sorting system 13, the identifier analysis portion 17 updates the database of rules. The database of rules may be updated by creating new rules relating to the selected identifiers 19, by amending existing rules for a particular additional identifier 18 based on whether the user 10 selected or rejected the additional identifiers 18, or linking two or more rules based on the selection by the user 10 of the additional identifiers 18 associated with the rules.

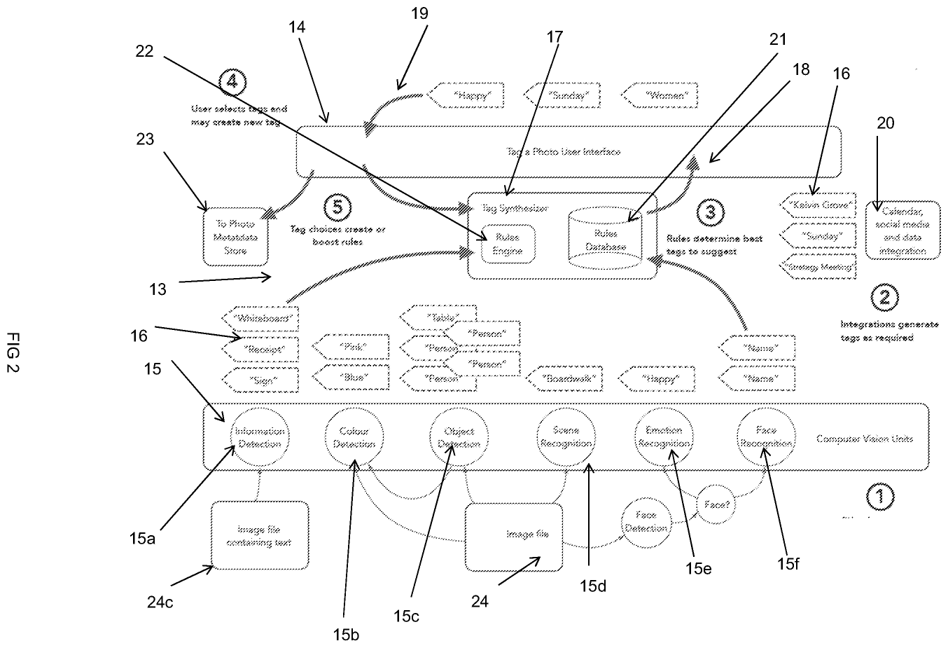

In FIG. 2 a schematic illustration of an electronic image sorting system 13 according to an embodiment of the present invention is shown. In this Figure, further details of the method and system shown in FIG. 1 are provided.

Initially, a digital image 24 is uploaded to the electronic image sorting system 13 by a user. The digital image 24 is analysed by the image analysis portion 15 of the system 13 to generate one or more initial identifiers 16. The image analysis portion 15 comprises a plurality of computer vision units adapted to analyse the digital image 24 for certain objects or properties of the digital image 24. For instance, a first computer vision unit 15a detects information, such as written information contained in digital image 24c. A second computer vision unit 15b detects predominant or significant colours in the digital image 24, while a third computer vision unit 15c detects objects.

A fourth computer vision unit 15d is adapted to recognise scenes (i.e. locations such as a beach, park etc.) while a fifth computer vision unit 15e recognises emotions within a digital image 24. Emotions are determined by detecting the presence of faces in the image 24 and then determining the expressions on the faces. For instance, a smiling face may generate an initial identifier of “happy”. In a similar vein, a sixth computer vision unit 15f is adapted to identify individuals within a digital image 24 through facial recognition.

In the embodiment of the invention shown in FIG. 2, initial identifiers 16 may also be generates by the electronic image sorting system 13 accessing a user's electronic personal data stores 20, such as social media accounts, Cloud storage, electronic calendar, location services (such as the current location of the user or their electronic device, or the location at a particular time in the past, such as when a particular photo was taken). One or more initial identifiers 16 may be generated from this information, such as the location at which a digital image was acquired, the event at which the digital image was acquired, and even the people present in the image, or when the image was acquired.

The initial identifiers 16 are then sent to an identifier analysis portion 17 of the electronic image sorting system 13. The identifier analysis portion 17 comprises a rules database 21 and a rules engine 22.

When initial identifiers 16 are received by the identifier analysis portion 17, the rules database 21 consults and/or enacts one or more rules that exactly and/or closely match the initial identifiers 16. In the embodiment of the invention illustrated in FIG. 2, intermediate identifiers may be generated based on the identifiers associated with the consulted and/or enacted rules. The intermediate identifiers are generated based on fuzzy logic.

In this embodiment of the invention, the one or more intermediate identifiers are weighted according to one or more criteria, such as their degree of matching to the initial identifiers 16, the frequency with which they have been used previously by the user and so on. It is envisaged that the more heavily weighted intermediate identifiers (i.e. those more closely matching the initial identifiers, or those used more frequently by a user) may become the additional identifiers 18, while less heavily weighted intermediate identifiers may be discarded.

It is envisaged that at least one of the one or more additional identifiers 18 will relate to the human meaning of the digital image 24. Thus, it is envisaged that the rules database 21 includes one or more rules that converts or translates an initial identifier 16 into its human meaning. For instance, while the face recognition computer vision unit 15f may recognise individuals within the digital image 24, the rules database 21 may recognise that the individuals in the digital image 24 together have an additional meaning to the user, such as “best friends” or “classmates”. The emotions felt by a user when viewing a particular digital image 24 may also be generated as additional identifiers 18 based on one or more rules in the rules database. For example, where the initial identifiers 16 may identify individuals within the digital image 24, the rules database 21 may generate an additional identifier 18 of “best friends” which may in turn consult and/or enact one or more further rules to generate additional identifiers 18 such as “fun”, “crazy”, “love” or the like. The additional identifiers 18 may be words, or may be emojis, electronic stickers, images or animations that embody the human meaning (such as a love heart for “love” and so on).

Preferably, the rules database 21 is federated across the electronic image sorting system 13, such that the same database of rules 21 is consulted for every user of the electronic image sorting system 13. Alternatively, users may be sorted into one or more categories based on one or more factors (age, gender, interests, geographical location etc.) such that only rules associated with, or relevant to, the one or more categories into which the user is sorted are consulted and/or enacted. In these embodiments of the invention, additional identifiers 18 may be weighted based on how closely they match identifiers selected by other users with similar factors to the user. In a specific example, if the user is a teenage female, additional identifiers 18 frequently used by other teenage females in the same city, state or country may be weighted more heavily than additional identifiers frequently used by males over 50, whether or not located in a similar geographical location.

Once a suitable number of additional identifiers 18 have been generated by the identifier analysis portion 17, the additional identifiers 18 are sent to the user via an electronic interface 14 that, in the embodiment of the invention illustrated in FIG. 2, is displayed on the electronic display of the electronic device associated with the user.

The user selects one or more of the additional identifiers 18 that he or she feels best described the digital image 24. The additional identifiers 18 selected by the user become the selected identifiers 19, and the selected identifiers 19 are associated with the digital image 24. A user may also manually generate their own selected identifiers 19 in addition to (or instead of) the additional identifiers 18 generated by the electronic image sorting system 13.

The selected identifiers 19 are electronically associated with the digital image 24 and are stored electronically by the electronic image sorting system 13 in electronic storage 23. It is envisaged that the digital image 24 will not be stored by the electronic image sorting system, but that a low-resolution thumbnail version of the digital image will be stored, along with the selected identifiers 19 and any other relevant metadata associated with the digital image 24.

Once the selected identifiers 19 have been generated by the user, the identifier analysis portion 17 reviews the selected identifiers 19 and modifies the relevant rules in the rules database 21. The modification of the rules in the rules database 21 may be of any suitable form. For instance, rules may be given greater or less weighting depending on whether an additional identifier 18 relating to that rule was selected as a selected identifier 19. Alternatively, rules may be linked or associated with one another if additional identifiers 18 relating to those rules are selected as selected identifiers 19 in the same digital image 24. Further, rules may be modified if the selected identifiers 19 relating to a particular object or person in an image change. For instance, a user may change their selected identifiers 19 for images containing a former partner, a deceased relative or the like from “happy” to “sad”. The rules in the rules database 21 may be modified accordingly when such a change in emotions occurs.

In other embodiments, new rules may be created based on selected identifiers 19. This may occur if, for instance, new words or expressions are coined, or if the meaning of words or expressions changes over time.

In the embodiment of the invention shown in FIG. 2, a user may also retrieve images stored across multiple electronic devices (and/or in Cloud storage or the like) using the electronic image sorting system 13. Specifically, a user may enter one or more selected identifiers into the user interface 14 in order to retrieve all images with which the selected identifier is associated. Preferably, the images that may be retrieved in this manner are limited to the user's own images (as opposed to the images of other users with which the same selected identifier is associated), although it is also envisaged that the user may grant permission to other users (such as friends or family) of the electronic image sorting system 13 to access to their images.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A method for sorting digital images, the method comprising the steps of:
a. Receiving a digital image acquired with an electronic device associated with a user, the digital image being sent using the electronic device to an electronic image sorting system;
b. Generating, using an image analysis portion of the electronic image sorting system, one or more initial identifiers based on the contents of the digital image;
c. Sending the one or more initial identifiers to an identifier analysis portion of the electronic image sorting system, wherein the identifier analysis portion includes an electronic database of one or more rules adapted to generate one or more additional identifiers based on the one or more initial identifiers;
d. Sending, using the electronic image sorting system, the one or more initial identifiers and/or the one or more additional identifiers, to the electronic device to allow the user to generate one or more selected identifiers from the one or more initial identifiers and/or the one or more additional identifiers; and
e. Modifying the one or more rules based on the one or more selected identifiers.

2. The method according to claim 1 wherein the electronic device is mobile telephone, computing tablet, desktop computer or laptop computer.

3. The method according to claim 1 wherein the electronic image sorting system includes a user interface in which the user may upload the digital image to the electronic image sorting system.

4. The method A method according to claim 1 wherein the image analysis portion includes one or more computer vision units capable of generating the one or more initial identifiers.

5. The method according to claim 1 wherein the image analysis portion generates the one or more initial identifiers based on based on one or more visual cues present in the digital image and/or one or more pieces of information retrieved from one or more information sources external to the electronic image sorting system and/or one or more pieces of information retrieved from metadata associated with the digital image.

6. The method according to claim 1 wherein the one or more rules are stored in an electronic rules database.

7. The method according to claim 1 wherein the identifier analysis portion generates one or more intermediate identifiers prior to the generation of the one or more additional identifiers.

8. The method according to claim 7 wherein the additional identifiers are generated from the intermediate identifiers using fuzzy logic and/or one or more weightings.

9. The method according to claim 8 wherein the one or more weightings include a higher weighting for intermediate identifiers that more closely match the initial identifiers and lower weightings for intermediate identifiers that less closely match the initial identifiers.

10. The method according to claim 1 wherein the one or more additional identifiers and/or the one or more initial identifiers are sent to an electronic interface displayed on a display of the electronic device.

11. The method according to claim 1 wherein at least one of the one or more additional identifiers relates to the human meaning of the digital image.

12. The method according to claim 1 wherein the rules are modified based on the one or more selected identifiers by generating new rules, updating rules with new selected identifiers, modifying the weighting of rules and/or linking or associating two or more rules.

13. The method according to claim 1 wherein the electronic image sorting system is adapted to retrieve digital images from one or more electronic devices based on one or more selected identifiers.

14. A system for sorting digital images, the system comprising: at least one processor, at least one non-transitory computer readable storage medium storing instructions thereon, that, when executed by the at least one processor, cause the system to:
a. Receive, from an electronic device associated with a user, a digital image sent using the electronic device to an electronic image sorting system;
b. Generate, using an image analysis portion of an electronic image sorting system, one or more initial identifiers based on the contents of a digital image;
c. Send, using the electronic image sorting system, the one or more initial identifiers to an identifier analysis portion of the electronic image sorting system, wherein the identifier analysis portion includes an electronic database of one or more rules adapted to generate one or more additional identifiers based on the one or more initial identifiers;
d. Send, using the electronic image sorting system, the one or more initial identifiers and/or the one or more additional identifiers, to the electronic device to allow the user to generate one or more selected identifiers from the one or more initial identifiers and/or the one or more additional identifiers; and
e. Modify, using the electronic image sorting system, the one or more rules based on the one or more selected identifiers.
